(19) United States
(12) Patent Application Publication
(10) Pub. No.: US 2025/0097931 A1
(43) Pub. Date: Mar. 20, 2025

(54) ANTENNA PANEL UNAVAILABILITY INDICATION

(71) Applicant: QUALCOMM Incorporated, San Diego, CA (US)

(72) Inventors: Luanxia YANG, Beijing (CN); Jing SUN, San Diego, CA (US); Aleksandar DAMNJANOVIC, Del Mar, CA (US); Changlong XU, Beijing (CN); Fang YUAN, Beijing (CN); Xiaoxia ZHANG, San Diego, CA (US); Shaozhen GUO, Beijing (CN); Siyi CHEN, Beijing (CN); Tao LUO, San Diego, CA (US)

(21) Appl. No.: 18/730,989

(22) PCT Filed: Mar. 10, 2022
(86) PCT No.: PCT/CN2022/080057

§ 371 Date: Jul. 22, 2024

(51) Int. Cl. H04W 72/12; H04W 8/24

(52) U.S. Cl. CPC H04W 72/12; H04W 8/24

(57) ABSTRACT

Various aspects of the present disclosure generally relate to wireless communication. In some aspects, a user equipment (UE) may transmit, to a network entity, a scheduling request that indicates full antenna panel availability or partial antenna panel availability. The UE may receive, from the network entity, an uplink grant that schedules an uplink communication in connection with the scheduling request, wherein the uplink grant is based at least in part on the full antenna panel availability or the partial antenna panel availability indicated by the scheduling request. Numerous other aspects are described.

### FIELD OF THE DISCLOSURE

Aspects of the present disclosure generally relate to wireless communication and to techniques and apparatuses for indicating antenna panel unavailability.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to transmit, to a network entity, a scheduling request that indicates full antenna panel availability or partial antenna panel availability. The one or more processors may be configured to receive, from the network entity, an uplink grant that schedules an uplink communication in connection with the scheduling request, wherein the uplink grant is based at least in part on the full antenna panel availability or the partial antenna panel availability indicated by the scheduling request.

Some aspects described herein relate to a network entity for wireless communication. The network entity may include a memory and one or more processors coupled to the memory. The one or more processors may be configured to receive a scheduling request that indicates full antenna panel availability or partial antenna panel availability associated with a UE. The one or more processors may be configured to transmit an uplink grant that schedules an uplink communication in connection with the scheduling request, wherein the uplink grant is based at least in part on the full antenna panel availability or the partial antenna panel availability indicated by the scheduling request.

Some aspects described herein relate to a method of wireless communication performed by a UE. The method may include transmitting, to a network entity, a scheduling request that indicates full antenna panel availability or partial antenna panel availability. The method may include receiving, from the network entity, an uplink grant that schedules an uplink communication in connection with the scheduling request, wherein the uplink grant is based at least in part on the full antenna panel availability or the partial antenna panel availability indicated by the scheduling request.

Some aspects described herein relate to a method of wireless communication performed by a network entity. The method may include receiving a scheduling request that indicates full antenna panel availability or partial antenna panel availability associated with a UE. The method may include transmitting an uplink grant that schedules an uplink communication in connection with the scheduling request, wherein the uplink grant is based at least in part on the full antenna panel availability or the partial antenna panel availability indicated by the scheduling request.

Some aspects described herein relate to a non-transitory computer-readable medium that stores a set of instructions for wireless communication by a UE. The set of instructions, when executed by one or more processors of the UE, may cause the UE to transmit, to a network entity, a scheduling request that indicates full antenna panel availability or partial antenna panel availability. The set of instructions, when executed by one or more processors of the UE, may cause the UE to receive, from the network entity, an uplink grant that schedules an uplink communication in connection with the scheduling request, wherein the uplink grant is based at least in part on the full antenna panel availability or the partial antenna panel availability indicated by the scheduling request.

Some aspects described herein relate to a non-transitory computer-readable medium that stores a set of instructions for wireless communication by a network entity. The set of instructions, when executed by one or more processors of the network entity, may cause the network entity to receive a scheduling request that indicates full antenna panel availability or partial antenna panel availability associated with a UE. The set of instructions, when executed by one or more processors of the network entity, may cause the network entity to transmit an uplink grant that schedules an uplink communication in connection with the scheduling request, wherein the uplink grant is based at least in part on the full antenna panel availability or the partial antenna panel availability indicated by the scheduling request.

Some aspects described herein relate to an apparatus for wireless communication. The apparatus may include means for transmitting, to a network entity, a scheduling request that indicates full antenna panel availability or partial antenna panel availability. The apparatus may include means for receiving, from the network entity, an uplink grant that schedules an uplink communication in connection with the scheduling request, wherein the uplink grant is based at least in part on the full antenna panel availability or the partial antenna panel availability indicated by the scheduling request.

Some aspects described herein relate to an apparatus for wireless communication. The apparatus may include means for receiving a scheduling request that indicates full antenna panel availability or partial antenna panel availability associated with a UE. The apparatus may include means for transmitting an uplink grant that schedules an uplink communication in connection with the scheduling request, wherein the uplink grant is based at least in part on the full antenna panel availability or the partial antenna panel availability indicated by the scheduling request.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating example of communication without UE cooperation and an example of communication with UE cooperation, in accordance with the present disclosure.

FIGS. 5-7 are diagrams illustrating examples associated with indicating antenna panel unavailability, in accordance with the present disclosure.

FIGS. 8-9 are diagrams illustrating example processes associated with indicating antenna panel unavailability, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

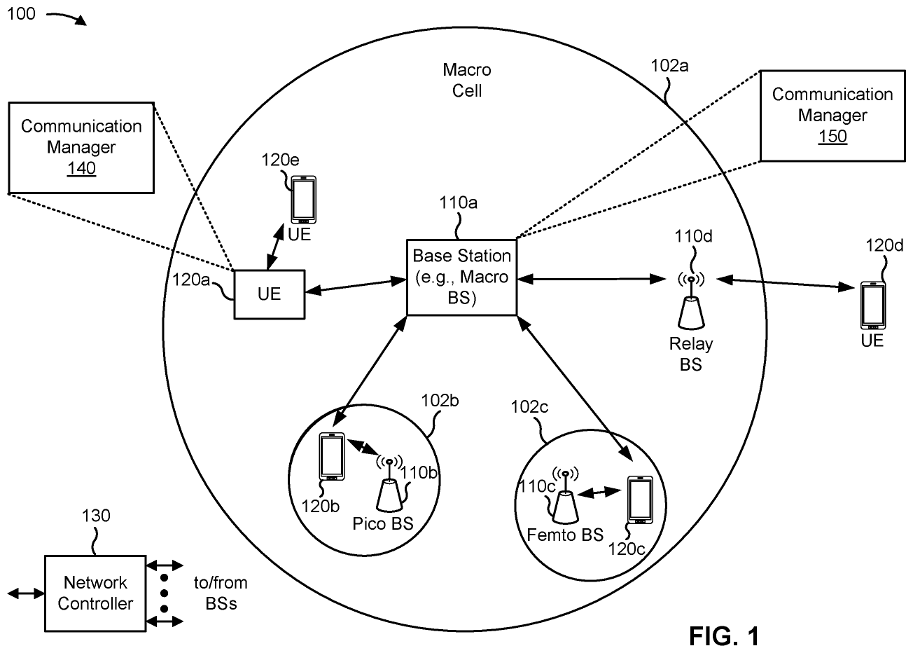

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network entity, a scheduling request that indicates full antenna panel availability or partial antenna panel availability; and receive, from the network entity, an uplink grant that schedules an uplink communication in connection with the scheduling request, wherein the uplink grant is based at least in part on the full antenna panel availability or the partial antenna panel availability indicated by the scheduling request. Additionally, or alternatively, the communication manager 140 may perform one or more other operations described herein.

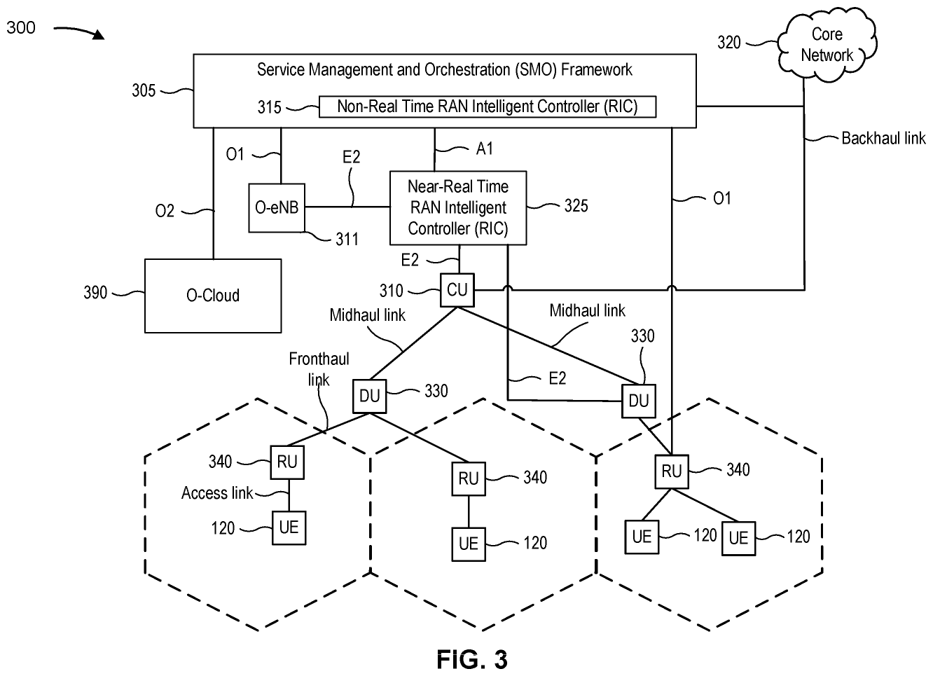

In some aspects, a network entity (e.g., a base station 110 or one or more components described in connection with FIG. 3) may include a communication manager 150. As described in more detail elsewhere herein, the communication manager 150 may receive a scheduling request that indicates full antenna panel availability or partial antenna panel availability associated with a UE; and transmit an uplink grant that schedules an uplink communication in connection with the scheduling request, wherein the uplink grant is based at least in part on the full antenna panel availability or the partial antenna panel availability indicated by the scheduling request. Additionally, or alternatively, the communication manager 150 may perform one or more other operations described herein.

As indicated above, FIG. 1 is provided as an example. Other examples may differ from what is described with regard to FIG. 1.

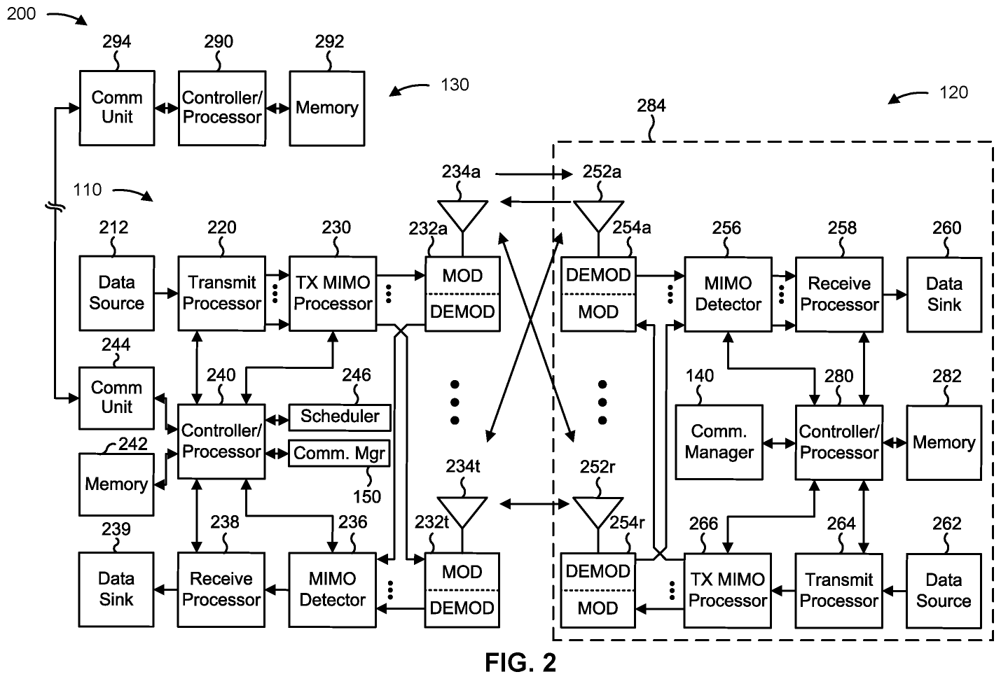

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

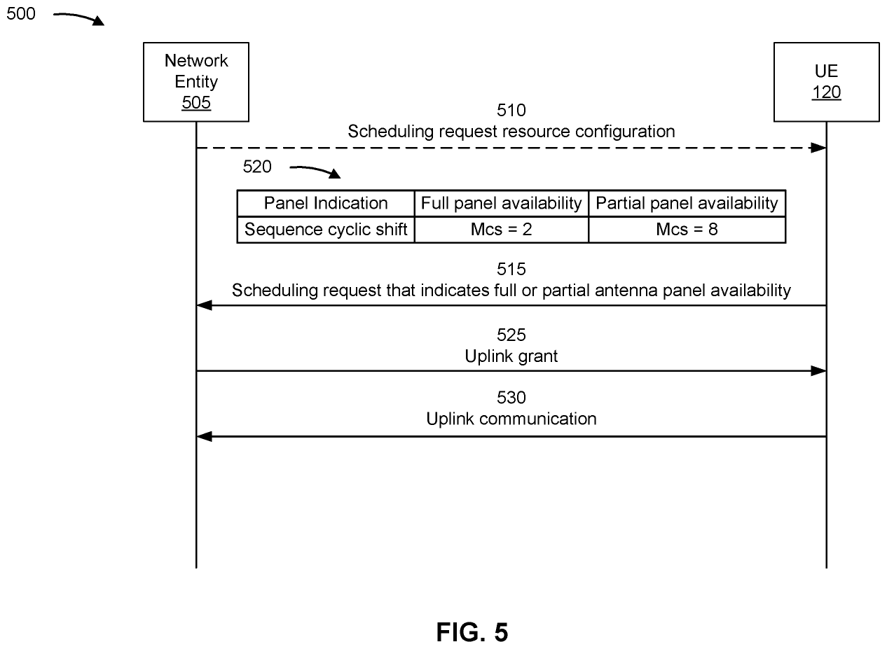

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

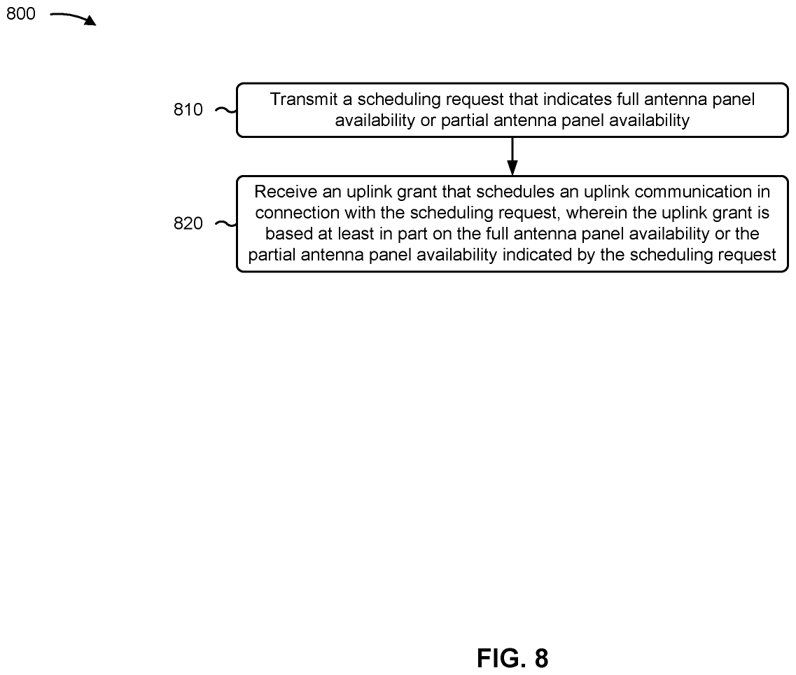

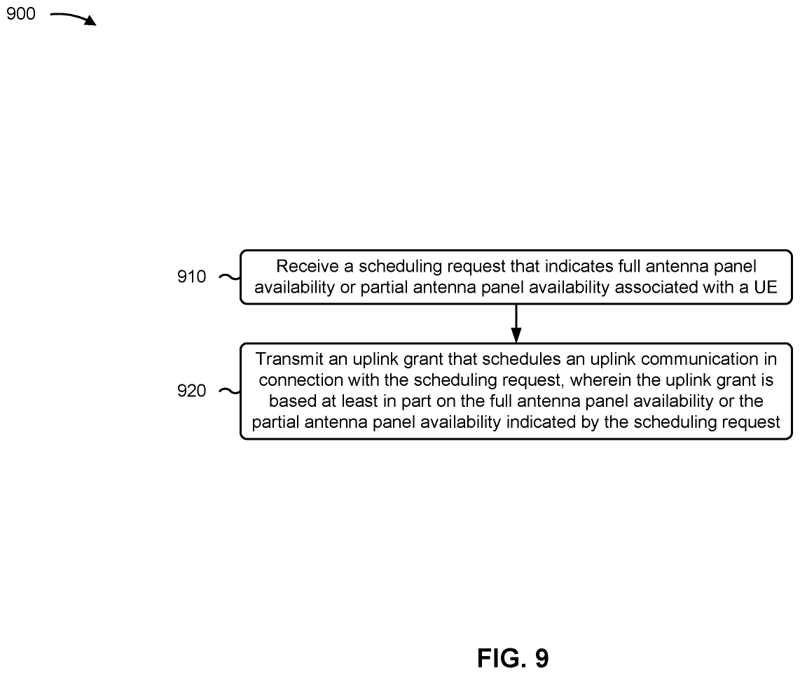

The controller/processor 240 of the base station 110, the controller/processor 280 of the UE 120, and/or any other component(s) of FIG. 2 may perform one or more techniques associated with indicating antenna panel unavailability, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2.

In some aspects, the UE 120 includes means for transmitting, to a network entity, a scheduling request that indicates full antenna panel availability or partial antenna panel availability; and/or means for receiving, from the network entity, an uplink grant that schedules an uplink communication in connection with the scheduling request, wherein the uplink grant is based at least in part on the full antenna panel availability or the partial antenna panel availability indicated by the scheduling request. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for receiving a scheduling request that indicates full antenna panel availability or partial antenna panel availability associated with a UE; and/or means for transmitting an uplink grant that schedules an uplink communication in connection with the scheduling request, wherein the uplink grant is based at least in part on the full antenna panel availability or the partial antenna panel availability indicated by the scheduling request. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 is a diagram illustrating an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with respect to FIG. 3.

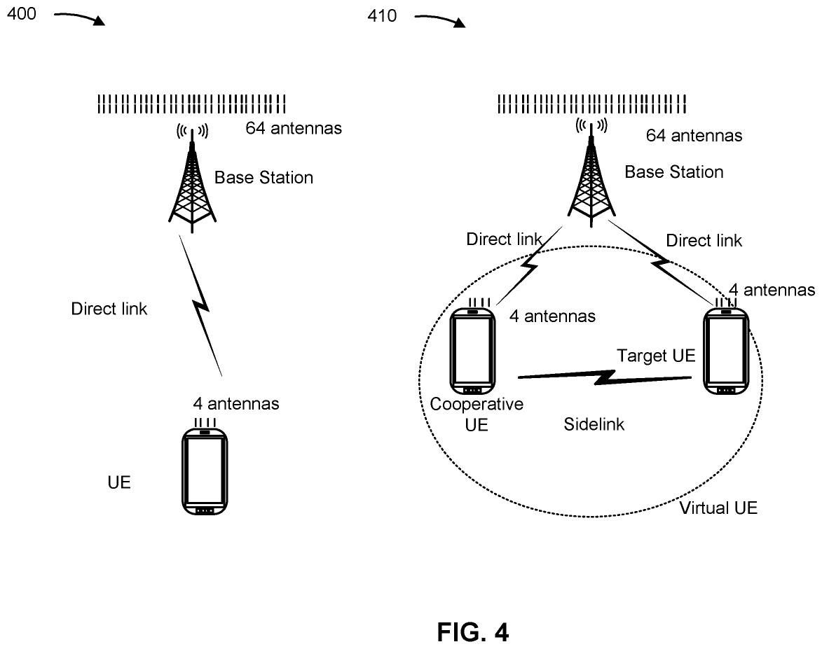

FIG. 4 is a diagram illustrating an example 400 of communication without UE cooperation and an example 410 of communication with UE cooperation, in accordance with the present disclosure, in accordance with the present disclosure.

In some cases, there may be a discrepancy between baseband processing capabilities and RF capabilities of a UE. For example, the processing capabilities of a baseband modem of a UE may be higher, in terms of bandwidth and/or data rate, than the RF capabilities of the UE. In such cases, the RF capabilities may limit the speed and throughput of communications between a UE and a base station, while the baseband processing capabilities of the UE may be underutilized.

As shown in example 400, a UE may communicate with a base station via a direct link between the base station and the UE. Beamforming may be performed to determine beams for the direct link between the base station and the UE. For example, in a case in which base station has 64 antennas and the UE has 4 antennas, as shown in example 400, beams formed on a combination of 64×4 antennas may be used for communications on the direct link between the base station and the UE. In some cases, the direct link between the base station and the UE may be subject to blockage issues (e.g., due to an obstacle between the base station and the UE) that may affect the network coverage for the UE and reduce the quality and/or reliability of communications between the base station and the UE. In some cases, the RF capabilities of the UE and/or a form factor of the UE may limit the bandwidth and/or data rate of communications between the base station and the UE, and thus limit the traffic throughput to and/or from the UE.

As shown in example 410, in some cases, UE cooperation may be used for communications between a target UE and a base station. UE cooperation may involve cooperation between the target UE and a cooperative UE for downlink communications directed to the target UE from the base station and/or uplink communications from the target UE to the base station. For example, the cooperative UE may be a neighboring UE to the target UE (e.g., within a certain range of the target UE) that is otherwise idle. In a case in which the cooperative UE is available to assist the target UE with communications between the target UE and the base station, the base station may treat the target UE and the cooperative UE as a single virtual UE. The base station may communicate with the virtual UE via a direct link between the base station and the target UE or via a direct link between the base station and the cooperative UE. Accordingly, communications between the target UE and the base station may be transmitted via the direct link between the base station and the target UE (e.g., a first path) or via the direct link between the base station and the cooperative UE and a sidelink between the cooperative UE and the target UE (e.g., a second path).

Beamforming may be used to determine beams for communications between the base station and the virtual UE. For example, the beamforming may determine whether the base station communicates with the virtual UE via the direct link between the base station and the target UE or via the direct link between the base station and the cooperative UE. In a case in which base station has 64 antennas, the target UE has 4 antennas, and the cooperative UE has 4 antennas, as shown in example 410, beamforming for communications between the base station and the virtual UE may be performed using 64×8 antennas. Accordingly, the use of UE cooperation results in increased link diversity for communications between the base station and the target UE, as compared to communications without UE cooperation (e.g., as shown in example 400). Such increased link diversity may reduce blockage issues, resulting in improved coverage for the target UE and increased quality, reliability, and/or throughput for communications between the base station and the target UE. The link budget for communications between the target UE and the base station may also be improved, as compared to communications without UE assistance, which may improve reliability of the communications, particularly in a case in which the target UE is a reduced capability UE. Furthermore, by utilizing RF capabilities of the cooperative UE in addition to or instead of the RF capabilities of the target UE, UE cooperation may result in an increase to the overall system capacity and/or traffic throughput in cases in which the system capacity and/or traffic throughput is limited by the RF capabilities of the target UE.

As indicated above, FIG. 4 is provided as an example. Other examples may differ from what is described with respect to FIG. 4.

As described above in connection with FIG. 4, in a case in which UE cooperation is utilized, a cooperative UE may assist a target UE with communications between the target UE and the base station. However, the target UE may have unexpected uplink data to transmit at a time at which the cooperative UE is unavailable. In this case, the base station may treat uplink communications from the target UE as uplink communications from a virtual UE that has the combined uplink transmission capabilities (e.g., antenna panels to be used for uplink transmission) of the target UE and the cooperative UE, but only the uplink transmission capabilities of the target UE may be available for transmitting the uplink data. As a result, the target UE may not be capable of transmitting the uplink data with uplink transmission parameters indicated by the base station, which may result in decreased reliability and throughput of uplink communications. Furthermore, even without UE cooperation, a UE may have multiple antenna panels for communication. If one antenna panel fails, the UE may have reduced uplink transmission capabilities and the base station may schedule an uplink communication that cannot be transmitted with the reduced uplink transmission capabilities caused by the failed antenna panel. This may result in decreased reliability and throughput of uplink communications.

Some techniques and apparatuses described herein enable a UE to transmit, to a network entity, a scheduling request that indicates full antenna panel availability or partial antenna panel availability. The UE may receive, from the network entity, an uplink grant that schedules an uplink communication in connection with the scheduling request, and the uplink grant may be based at least in part on the full antenna panel availability or partial antenna panel availability indicated by the scheduling request. The UE may transmit a scheduling request that indicates partial antenna panel availability in connection with a cooperative UE being unavailable or in connection with an antenna panel, of multiple antenna panels of the UE, being unavailable. As a result, the network entity, in connection with receiving the scheduling request, may set transmission parameters for the uplink communication in accordance with the antenna panel availability for the UE. This may increase reliability and throughput for uplink communications, particularly in cases in which a cooperative UE that assists another UE is unavailable and/or in cases in which an antenna panel, of multiple antenna panels of a UE, is unavailable.

FIG. 5 is a diagram illustrating an example 500 associated with indicating antenna panel unavailability, in accordance with the present disclosure. As shown in FIG. 5, example 500 includes communication between a network entity 505 (e.g., base station 110, CU 310, DU 330, RU 340, or a combination thereof) and a UE 120. In some aspects, the network entity 505 and the UE 120 may be included in a wireless network, such as wireless network 100. The network entity 505 and the UE 120 may communicate via a wireless access link, which may include an uplink and a downlink.

In some aspects, a cooperative UE may assist the UE 120 with communications between the UE 120 and the network entity 505. In this case, the network entity 505 may treat the UE 120 and the cooperative UE as a virtual UE. For example, downlink communications transmitted to the virtual UE from the network entity 505 may be transmitted via a direct link between the network entity 505 and the UE 120, or may be transmitted via a direct link between the network entity 505 and the cooperative UE and a sidelink between the cooperative UE and the UE 120. Similarly, uplink communications received by the network entity 505 from the virtual UE may be transmitted from the UE 120 via a direct link between the UE 120 and the network entity 505, or via a sidelink between the UE 120 and the cooperative UE and a direct link between the cooperative UE and the network entity 505.

As shown in FIG. 5, and by reference number 510, the network entity 505 may transmit, to the UE 120, a scheduling request resource configuration. The UE 120 may receive the scheduling request resource configuration transmitted by the network entity 505. For example, the network entity 505 may transmit the scheduling request resource configuration to the UE 120 in an RRC message. A scheduling request is a request for uplink resources (e.g., physical uplink shared channel (PUSCH) resources) for a new uplink transmission. The scheduling request resource configuration may indicate a configuration of physical uplink control channel (PUCCH) resources (e.g., time and/or frequency resources) for the UE 120 to use to transmit scheduling requests to the network entity 505. In some aspects, the scheduling request resource configuration may indicate a configuration of periodic PUCCH resources for scheduling requests.

As further shown in FIG. 5, and by reference number 515, the UE 120 may transmit, to the network entity 505, a scheduling request that indicates full antenna panel availability or partial antenna panel availability for the UE 120. The network entity 505 may receive the scheduling request transmitted by the UE 120. In some aspects, the UE 120 may transmit the scheduling request in a PUCCH communication. For example, the UE 120 may transmit the scheduling request in a PUCCH resource configured in the scheduling request resource configuration received from the network entity 505. The UE 120 may transmit the scheduling request to the network entity 505 to request resources for an uplink communication (e.g., a PUSCH communication). In some aspects, the UE 120 may transmit the scheduling request in connection with a determination that the UE 120 has uplink data to transmit to the network entity 505. For example, the UE 120 may transmit the scheduling request in connection with uplink data to be transmitted by the UE 120 arriving in a buffer of the UE 120.

The scheduling request may indicate whether antenna panels associated with the UE 120 are fully available or partially available for the uplink communication (e.g., at the time of the scheduling request). In some aspects, the UE 120 and a cooperative UE may be associated with a virtual UE for communications between the UE 120 and the network entity 505. In this case, the UE 120 may transmit a scheduling request that indicates full antenna panel availability in connection with the cooperative UE being available, and the UE 120 may transmit a scheduling request that indicates partial antenna panel availability in connection with the cooperative UE not being available. That is, the scheduling request may indicate full antenna panel availability when the antenna panels associated with the virtual UE (e.g., the antenna panel of the UE 120 and the antenna panel of the cooperative UE) are fully available, and the scheduling request may indicate partial antenna panel availability when the antenna panel associated with the cooperative UE is unavailable. For example, the cooperative UE may be unavailable when the cooperative UE is in an “off” period in a discontinuous reception (DRX) cycle.

In some aspects, the UE 120 may have multiple antenna panels. For example, the UE 120 may have a first antenna panel and a second antenna panel. In this case, the UE 120 may transmit a scheduling request that indicates full antenna panel availability in connection with all of the antenna panels of the UE 120 (e.g., the first antenna panel and the second antenna panel) being available, or the UE 120 may transmit a scheduling request that indicates partial antenna panel availability in connection with one of the antenna panels of the UE 120 (e.g., the first antenna panel or the second antenna panel) being unavailable. For example, an antenna panel of the UE 120 may be unavailable due to failure of the antenna panel.

In some aspects, different scheduling requests (e.g., different types of scheduling requests) may be used to indicate full antenna panel availability and partial antenna panel availability. For example, a first scheduling request (e.g., schedulingrequestID-WPA) may indicate full antenna panel availability (e.g., whole panel available), and a second scheduling request (e.g., schedulingrequestID-PPA) may indicate partial antenna panel availability (e.g., partial panel availability). The first scheduling request may be a first type of scheduling request associated with a first scheduling request identifier (ID), and the second scheduling request may be a second type of scheduling request associated with a second scheduling request ID. In some aspects, the UE 120 may transmit the first scheduling request to indicate full antenna panel availability, or the UE 120 may transmit the second scheduling request to indicate partial antenna panel availability.

In some aspects, a sequence cyclic shift used for the scheduling request may indicate full antenna panel availability or partial antenna panel availability. In this case, different sequence cyclic shifts may map to different numbers of available antenna panels. For example, a first sequence cyclic shift may map to an indication of full antenna panel availability and a second sequence cyclic shift may map to an indication of partial antenna panel availability. In some aspects, the UE 120 may transmit the scheduling request with the first sequence cyclic shift that corresponds to full antenna panel availability or a second sequence cyclic shift that corresponds to partial antenna panel availability. In some aspects, the mapping between the sequence cyclic shift and the indication of antenna panel availability may be a preconfigured mapping, such as a mapping specified in a wireless communication standard (e.g., a 3GPP standard), or the mapping between the sequence cyclic shift and the indication of antenna panel availability may be configured for the UE 120 (e.g., via RRC signaling) by the network entity 505. As shown in FIG. 5, and by reference number 520, in an example mapping between the sequence cyclic shift m_{cs} and the antenna panel availability indication, a sequence cyclic shift of m_{c}=2 may correspond to an indication of full antenna panel availability, and a sequence cyclic shift of m_{c}=8 may correspond to an indication of partial antenna panel availability. In some aspects, in a case in which the sequence cyclic shift indicates full or partial antenna panel availability, a beam failure recovery (BFR) scheduling request may be used as the scheduling request with the sequence cyclic shift that indicates full or partial antenna panel availability.

In some aspects, different scheduling request resources may be configured for transmitting a scheduling request that indicates full antenna panel availability and a scheduling request that indicates partial antenna panel availability. For example, the scheduling request resource configuration transmitted from the network entity 505 to the UE 120 may indicate a configuration for a first scheduling request resource (e.g., a first PUCCH resource) associated with indicating full antenna panel availability and a second scheduling request resource (e.g., a second PUCCH resource) associated with indicating partial antenna panel availability. In this case, the UE 120 may transmit the scheduling request in the first scheduling request resource to indicate full antenna panel availability, or the UE 120 may transmit the scheduling request in the second scheduling request resource to indicate partial antenna panel availability.

In some aspects, in connection with a determination that there is hybrid automatic repeat request acknowledgement (HARQ-ACK) information to be transmitted by the UE 120 (e.g., in connection with a downlink communication received from the network entity 505), the UE 120 may multiplex the HARQ-ACK information and the scheduling request. That is, the UE 120 may transit the scheduling request multiplexed with HARQ-ACK information in a same PUCCH communication. For example, the PUCCH communication may be a PUCCH format 0 communication. In some aspects, values for one HARQ-ACK information bit and two bits for a positive scheduling request may be mapped to different sequence cyclic shifts for PUCCH format 0. In this case, the UE 120 may transmit the PUCCH communication using a sequence cyclic shift that maps to a value for a HARQ-ACK information bit (e.g., 0 or 1) and an indication of full antenna panel availability or partial antenna panel availability. In some aspects, values for two HARQ-ACK information bits and two bits for a positive scheduling request may map to sequence cyclic shifts for PUCCH format 0. In this case, the UE 120 may transmit the PUCCH communication using a sequence cyclic shift that maps to a pair of values for two HARQ-ACK information bits and an indication of the full antenna panel availability or the partial antenna panel availability.

In some aspects, the UE 120 may transmit the scheduling request in a PUCCH format 1 communication. In this case, if the UE 120 is configured with a first resource in a slot for transmitting the scheduling request (e.g., a positive scheduling request) using PUCCH format 1 and at most two HARQ-ACK information bits are to be transmitted by the UE 120 in a second resource in the slot using PUCCH format 1, the UE 120 may transmit a PUCCH communication with the HARQ-ACK information bits in the first resource using PUCCH format 1. In this case, the transmission of the HARQ-ACK information bits in the first resource, instead of the second resource, may indicate to the network entity 505 that the UE 120 has a positive scheduling request. In some aspects, the UE 120 may transmit the PUCCH communication that includes the HARQ-ACK information bits in the first resource using a sequence cyclic shift that maps to an indication of full antenna panel availability or partial antenna panel availability for the scheduling request. For example, in a case in which a first PUCCH resource in a slot is allocated for the scheduling request and a second PUCCH resource in the slot is allocated for one or more HARQ-ACK information bits, the UE 120 may transmit a PUCCH communication including the scheduling request and the one or more HARQ-ACK information bits in the first PUCCH resource using PUCCH format 1 with a sequence cyclic shift that indicates the full antenna panel availability or the partial antenna panel availability.

As further shown in FIG. 5, and by reference number 525, the network entity 505, in connection with receiving the scheduling request, may transmit an uplink grant to the UE 120. The UE 120 may receive the uplink grant transmitted by the network entity 505. For example, the uplink grant may be included in DCI (e.g., DCI format 0_0 or DCI format 0_1) transmitted in a physical downlink control channel (PDCCH) communication. The uplink grant may schedule an uplink communication (e.g., PUSCH communication) for the UE 120. For example, the uplink grant may indicate resources (e.g., time and frequency resources), as well as other transmission parameters, for the uplink communication (e.g., PUSCH communication) scheduled for the UE 120.

In some aspects, the uplink grant may be based at least in part on the indication of full antenna panel availability or partial antenna panel availability provided by the scheduling request. For example, the network entity 505 may determine one or more transmission parameters (e.g., maximum rank and/or uplink transmit power) indicated in the uplink grant based at least in part on whether the scheduling request indicated full antenna panel availability or partial antenna panel availability. In some aspects, the network entity 505 may determine, in connection with an indication of partial antenna panel availability, that multiple TRP (multi-TRP) communications are not supported, and the network entity 505 may indicate, to the UE 120, to fall back to single TRP communications. In some aspects, in a case in which the scheduling request indicates partial antenna panel availability, the network entity 505 may indicate, in the uplink grant, a maximum rank for the scheduled uplink communication that is half of the maximum rank indicated in the uplink grant in a case in which the scheduling request indicates full antenna panel availability. In some aspects, in a case in which the scheduling request indicates partial antenna panel availability, the network entity 505 may indicate, in the uplink grant, a maximum uplink transmit power for the scheduled uplink communication that is half of the maximum uplink transmit power indicated in the uplink grant in a case in which the scheduling request indicates full antenna panel availability.

As further shown in FIG. 5, and by reference number 530, the UE 120 may transmit, to the network entity 505, the uplink communication (e.g., PUSCH communication) scheduled by the uplink grant. The network entity 505 may receive the uplink communication transmitted by the UE 120. The UE 120 may transmit the uplink communication using the resources indicated in the uplink grant and in accordance with the uplink transmission parameters indicated in the uplink grant (e.g., including uplink transmission parameters based at least in part on the indication of full or partial antenna panel availability provided by the scheduling request).

As describe above, the UE 120 may transmit, to the network entity 505, a scheduling request that indicates full panel antenna panel availability or partial antenna panel availability. The UE 120 may receive, from the network entity 505, an uplink grant that schedules an uplink communication in connection with the scheduling request, and the uplink grant may be based at least in part on the indication of full antenna panel availability or partial antenna panel availability provided by the scheduling request. As a result, the network entity, in connection with receiving the scheduling request, may set transmission parameters for the uplink communication in accordance with the antenna panel availability for the UE. This may increase reliability and throughput for uplink communications, particularly in cases in which a cooperative UE that assists the UE 120 is unavailable and/or in cases in which an antenna panel, of multiple antenna panels of the UE 120, is unavailable.

As indicated above, FIG. 5 is provided as an example. Other examples may differ from what is described with respect to FIG. 5.

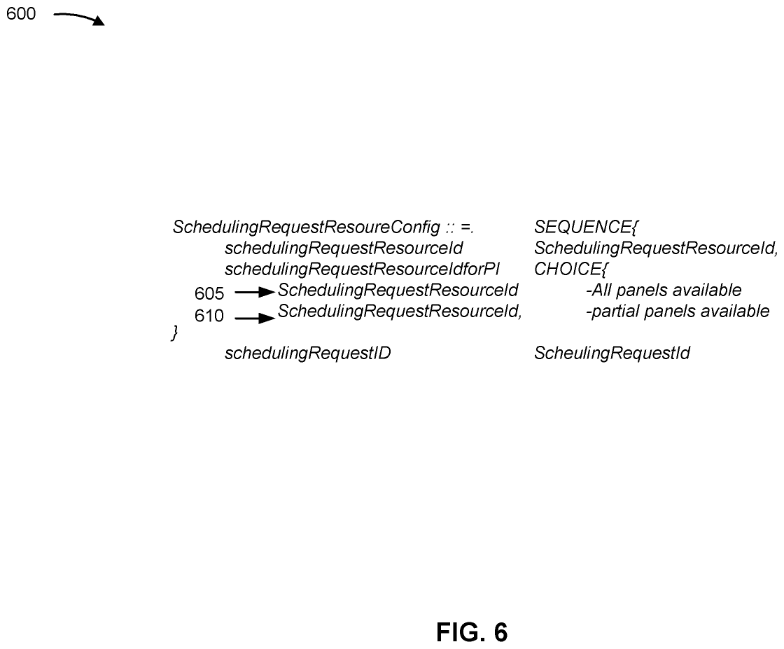

FIG. 6 is a diagram illustrating an example 600 associated with indicating antenna panel unavailability, in accordance with the present disclosure. As described above in connection with FIG. 5, in some aspects, a UE may transmit, to a network entity, a scheduling request that indicates full antenna panel availability or partial antenna panel availability. In some aspects, the UE may transmit the scheduling request in a first scheduling request resource associated with indicating full antenna panel availability or a second scheduling request resource associated with indicating partial antenna panel availability. In this case, the network entity may transmit, to the UE, a scheduling request resource configuration that indicates a configuration for the first scheduling request resource and a configuration for the second scheduling request resource.

As shown in FIG. 6, example 600 shows an example of a scheduling request resource configuration that identifies different scheduling request resources for indicating full antenna panel availability and partial antenna panel availability. The scheduling request resource configuration may use two resource pointers to indicate scheduling request resources for indicating full and partial antenna panel availability. For example, as shown in FIG. 6, a scheduling request resource ID that provides an antenna panel availability indication (e.g., schedulingRequestResourceldforPI) may be a first scheduling request resource ID 605 that identifies a first scheduling request resource for indicating full antenna panel availability or a second scheduling request resource ID 610 that identifies a second scheduling request resource for indicating partial antenna panel availability.

As indicated above, FIG. 6 is provided as an example. Other examples may differ from what is described with respect to FIG. 6.

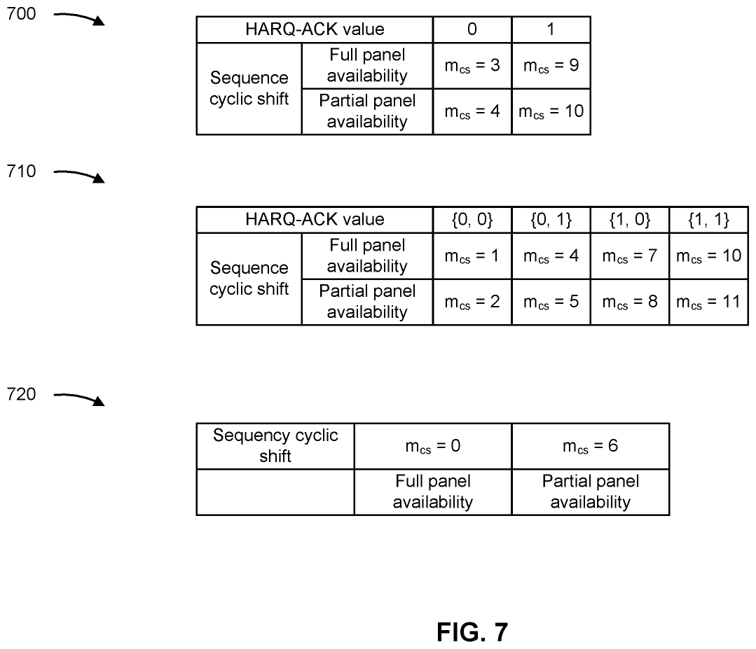

FIG. 7 is a diagram illustrating examples 700, 710, and 720 associated with indicating antenna panel unavailability, in accordance with the present disclosure.

In some aspects, a UE may transmit, to a network entity, a scheduling request that indicates full antenna panel availability or partial antenna panel availability. In some aspects, in a case in which the UE multiplexes the scheduling request with HARQ-ACK information in a PUCCH communication (e.g., a PUCCH format 0 communication), values for one HARQ-ACK information bit and two bits for a positive scheduling request may be mapped to different sequence cyclic shifts for PUCCH format 0. In this case, the UE 120 may transmit the PUCCH communication using a sequence cyclic shift that maps to a value for a HARQ-ACK information bit (e.g., 0 or 1) and an indication of full antenna panel availability or partial antenna panel availability. As shown in FIG. 7, example 700 shows an example of a mapping of a sequence cyclic shift m_{c} to a one-bit HARQ-ACK value and an indication of full antenna panel availability or partial antenna panel availability. As shown in example 700, a sequence cyclic shift of m_{c}=3 may map to a one-bit HARQ-ACK value of 0 and an indication of full antenna panel availability, a sequence cyclic shift of m_{c}=4 may map to a one-bit HARQ-ACK value of 0 and an indication of partial antenna panel availability, a sequence cyclic shift of m_{c}=9 may map to a one-bit HARQ-ACK value of 1 and an indication of full antenna panel availability, and a sequence cyclic shift of m_{c}=10 may map to a one-bit HARQ-ACK value of 1 and an indication of partial antenna panel availability. In some aspects, such a mapping may be specified in a wireless communication standard (e.g., 3GPP standard) or may be configured for the UE (e.g., via RRC signaling) by the network entity.

In some aspects, values for two HARQ-ACK information bits and two bits for a positive scheduling request may map to sequence cyclic shifts for PUCCH format 0. In this case, the UE 120 may transmit the PUCCH communication using a sequence cyclic shift that maps to a pair of values for two HARQ-ACK information bits and an indication of the full antenna panel availability or the partial antenna panel availability. As shown in FIG. 7, example 710 shows an example of a mapping of a sequence cyclic shift m_{c} to a pair of values for two HARQ-ACK information bits (e.g., a two-bit HARQ-ACK value) and an indication of full antenna panel availability or partial antenna panel availability. As shown in example 710, a sequence cyclic shift of m_{c}=1 may map to a two-bit HARQ-ACK value of {0, 0} and an indication of full antenna panel availability, a sequence cyclic shift of m_{c}=2 may map to a two-bit HARQ-ACK value of {0, 0} and an indication of partial antenna panel availability, a sequence cyclic shift of m_{c}=4 may map to a two-bit HARQ-ACK value of {0, 1} and an indication of full antenna panel availability, a sequence cyclic shift of m_{cs}=5 may map to a two-bit HARQ-ACK value of {0, 1} and an indication of partial antenna panel availability, a sequence cyclic shift of m_{cs}=7 may map to a two-bit HARQ-ACK value of {1, 0} and an indication of full antenna panel availability, a sequence cyclic shift of m_{cs}=8 may map to a two-bit HARQ-ACK value of {1, 0} and an indication of partial antenna panel availability, a sequence cyclic shift of m_{cs}=10 may map to a two-bit HARQ-ACK value of {1, 1} and an indication of full antenna panel availability, and a sequence cyclic shift of m_{c}s=11 may map to a two-bit HARQ-ACK value of {1, 1} and an indication of partial antenna panel availability. In some aspects, such a mapping may be specified in a wireless communication standard (e.g., 3GPP standard) or may be configured for the UE (e.g., via RRC signaling) by the network entity.

In some aspects, in a case in which a first PUCCH resource in a slot is allocated for a scheduling request and a second PUCCH resource in the slot is allocated for one or more HARQ-ACK information bits, the UE 120 may transmit a PUCCH communication including the scheduling request and the one or more HARQ-ACK information bits in the first PUCCH resource using PUCCH format 1 with a sequence cyclic shift that indicates the full antenna panel availability or the partial antenna panel availability. As shown in FIG. 7, example 720 shows an example of a mapping between a sequence cyclic shift m_{c} and an indication of full antenna panel availability or partial antenna panel availability for a PUCCH format 1 communication that includes HARQ-ACK in a PUCCH resource allocated for the scheduling request. As shown in example 720, a sequence cyclic shift of m_{c}=0 may map to an indication of full antenna panel availability, and a sequence cyclic shift of m_{c}=6 may map to an indication of partial antenna panel availability. In some aspects, such a mapping may be specified in a wireless communication standard (e.g., 3GPP standard) or may be configured for the UE (e.g., via RRC signaling) by the network entity.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with indicating antenna panel unavailability.

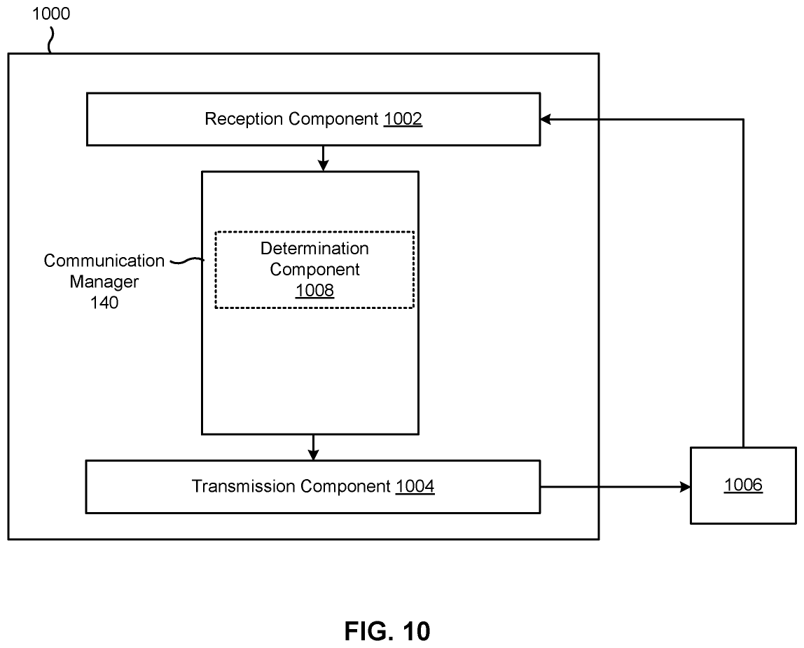

As shown in FIG. 8, in some aspects, process 800 may include transmitting, to a network entity, a scheduling request that indicates full antenna panel availability or partial antenna panel availability (block 810). For example, the UE (e.g., using communication manager 140 and/or transmission component 1004, depicted in FIG. 10) may transmit, to a network entity, a scheduling request that indicates full antenna panel availability or partial antenna panel availability, as described above.

As further shown in FIG. 8, in some aspects, process 800 may include receiving, from the network entity, an uplink grant that schedules an uplink communication in connection with the scheduling request, wherein the uplink grant is based at least in part on the full antenna panel availability or the partial antenna panel availability indicated by the scheduling request (block 820). For example, the UE (e.g., using communication manager 140 and/or reception component 1002, depicted in FIG. 10) may receive, from the network entity, an uplink grant that schedules an uplink communication in connection with the scheduling request, wherein the uplink grant is based at least in part on the full antenna panel availability or the partial antenna panel availability indicated by the scheduling request, as described above.

Process 800 may include additional aspects, such as any single aspect or any combination of aspects described below and/or in connection with one or more other processes described elsewhere herein.

In a first aspect, transmitting the scheduling request includes transmitting a first scheduling request that indicates the full antenna panel availability or a second scheduling request that indicates the partial antenna panel availability.

In a second aspect, transmitting the scheduling request includes transmitting the scheduling request with a sequence cyclic shift that indicates the full antenna panel availability or the partial antenna panel availability.

In a third aspect, transmitting the scheduling request with the sequence cyclic shift that indicates the full antenna panel availability or the partial antenna panel availability includes transmitting the scheduling request with a first sequence cyclic shift that corresponds to the full antenna panel availability or a second sequence cyclic shift that corresponds to the partial antenna panel availability.

In a fourth aspect, the scheduling request is a beam failure recovery scheduling request with the sequence cyclic shift that indicates the full antenna panel availability or the partial antenna panel availability.

In a fifth aspect, transmitting the scheduling request includes transmitting the scheduling request in a first scheduling request resource associated with indicating the full antenna panel availability or a second scheduling request resource associated with indicating the partial antenna panel availability.

In a sixth aspect, process 800 includes receiving, from the network entity, a scheduling request resource configuration that indicates a configuration for the first scheduling request resource and a configuration for the second scheduling request resource.

In a seventh aspect, transmitting the scheduling request includes transmitting the scheduling request multiplexed with HARQ-ACK information in a PUCCH communication.

In an eighth aspect, the PUCCH communication is a PUCCH format 0 communication.

In a ninth aspect, transmitting the scheduling request multiplexed with HARQ-ACK information in the PUCCH communication includes transmitting the PUCCH communication using a sequence cyclic shift that maps to a value for a HARQ-ACK information bit and an indication of the full antenna panel availability or the partial antenna panel availability.

In a tenth aspect, transmitting the scheduling request multiplexed with HARQ-ACK information in the PUCCH communication includes transmitting the PUCCH communication using a sequence cyclic shift that maps to a pair of values for two HARQ-ACK information bits and an indication of the full antenna panel availability or the partial antenna panel availability.

In an eleventh aspect, transmitting the scheduling request includes transmitting, in connection with a PUCCH resource in a slot being allocated for the scheduling request and a second PUCCH resource in the slot being allocated for one or more HARQ-ACK information bits, a PUCCH communication including the scheduling request and the one or more HARQ-ACK information bits in the first PUCCH resource using PUCCH format 1 with a sequence cyclic shift that indicates the full antenna panel availability or the partial antenna panel availability.

In a twelfth aspect, the scheduling request indicating the full antenna panel availability or the partial antenna panel availability is based at least in part on an availability of a cooperative UE.

In a thirteenth aspect, process 800 includes transmitting the uplink communication scheduled by the uplink grant.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network entity 505, base station 110, CU 310, DU 330, RU 340, or a combination thereof) performs operations associated with indicating antenna panel unavailability.

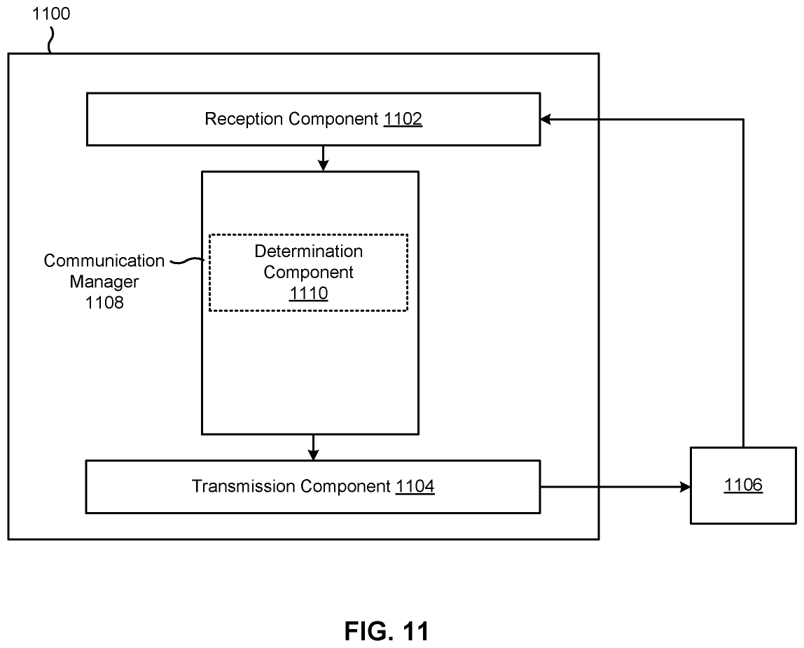

As shown in FIG. 9, in some aspects, process 900 may include receiving a scheduling request that indicates full antenna panel availability or partial antenna panel availability associated with a UE (block 910). For example, the network entity (e.g., using communication manager 1108 and/or reception component 1102, depicted in FIG. 11) may receive a scheduling request that indicates full antenna panel availability or partial antenna panel availability associated with a UE, as described above.

As further shown in FIG. 9, in some aspects, process 900 may include transmitting an uplink grant that schedules an uplink communication in connection with the scheduling request, wherein the uplink grant is based at least in part on the full antenna panel availability or the partial antenna panel availability indicated by the scheduling request (block 920). For example, the network entity (e.g., using communication manager 1108 and/or transmission component 1104, depicted in FIG. 11) may transmit an uplink grant that schedules an uplink communication in connection with the scheduling request, wherein the uplink grant is based at least in part on the full antenna panel availability or the partial antenna panel availability indicated by the scheduling request, as described above.

Process 900 may include additional aspects, such as any single aspect or any combination of aspects described below and/or in connection with one or more other processes described elsewhere herein.

In a first aspect, receiving the scheduling request includes receiving a first scheduling request that indicates the full antenna panel availability or a second scheduling request that indicates the partial antenna panel availability.

In a second aspect, receiving the scheduling request includes receiving the scheduling request with a sequence cyclic shift that indicates the full antenna panel availability or the partial antenna panel availability.

In a third aspect, receiving the scheduling request with the sequence cyclic shift that indicates the full antenna panel availability or the partial antenna panel availability includes receiving the scheduling request with a first sequence cyclic shift that corresponds to the full antenna panel availability or a second sequence cyclic shift that corresponds to the partial antenna panel availability.

In a fourth aspect, the scheduling request is a beam failure recovery scheduling request with the sequence cyclic shift that indicates the full antenna panel availability or the partial antenna panel availability.

In a fifth aspect, receiving the scheduling request includes receiving the scheduling request in a first scheduling request resource associated with indicating the full antenna panel availability or a second scheduling request resource associated with indicating the partial antenna panel availability.

In a sixth aspect, process 900 includes transmitting a scheduling request resource configuration that indicates a configuration for the first scheduling request resource and a configuration for the second scheduling request resource.

In a seventh aspect, receiving the scheduling request includes receiving the scheduling request multiplexed with HARQ-ACK information in a PUCCH communication.

In an eighth aspect, the PUCCH communication is a PUCCH format 0 communication.

In a ninth aspect, receiving the scheduling request multiplexed with HARQ-ACK information in the PUCCH communication includes receiving the PUCCH communication using a sequence cyclic shift that maps to a value for a HARQ-ACK information bit and an indication of the full antenna panel availability or the partial antenna panel availability.

In a tenth aspect, receiving the scheduling request multiplexed with HARQ-ACK information in the PUCCH communication includes receiving the PUCCH communication using a sequence cyclic shift that maps to a pair of values for two HARQ-ACK information bits and an indication of the full antenna panel availability or the partial antenna panel availability.

In an eleventh aspect, receiving the scheduling request includes receiving, in connection with a first PUCCH resource in a slot being allocated for the scheduling request and a second PUCCH resource in the slot being allocated for one or more HARQ-ACK information bits, a PUCCH communication including the scheduling request and the one or more HARQ-ACK information bits in the first PUCCH resource using PUCCH format 1 with a sequence cyclic shift that indicates the full antenna panel availability or the partial antenna panel availability.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a determination component 1008, among other examples.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit, to a network entity, a scheduling request that indicates full antenna panel availability or partial antenna panel availability. The reception component 1002 may receive, from the network entity, an uplink grant that schedules an uplink communication in connection with the scheduling request, wherein the uplink grant is based at least in part on the full antenna panel availability or the partial antenna panel availability indicated by the scheduling request.

The reception component 1002 may receive, from the network entity, a scheduling request resource configuration that indicates a configuration for the first scheduling request resource and a configuration for the second scheduling request resource.

The transmission component 1004 may transmit the uplink communication scheduled by the uplink grant.

The determination component 1008 may determine whether to indicate the full antenna panel availability or the partial antenna panel availability.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network entity, or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108. The communication manager 1108 may include a determination component 1110, among other examples.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the base station described in connection with FIG. 2. The communication manager 1108 may be, or be similar to, the communication manager 150 depicted in FIGS. 1 and 2. For example, in some aspects, the communication manager 1108 may be configured to perform one or more of the functions described as being performed by the communication manager 150. In some aspects, the communication manager 1108 may include the reception component 1102 and/or the transmission component 1104.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The reception component 1102 may receive a scheduling request that indicates full antenna panel availability or partial antenna panel availability associated with a UE. The transmission component 1104 may transmit an uplink grant that schedules an uplink communication in connection with the scheduling request, wherein the uplink grant is based at least in part on the full antenna panel availability or the partial antenna panel availability indicated by the scheduling request.

The transmission component 1104 may transmit a scheduling request resource configuration that indicates a configuration for the first scheduling request resource and a configuration for the second scheduling request resource.

The determination component 1110 may determine the uplink grant based at least in part on the full antenna panel availability or the partial antenna panel availability indicated by the scheduling request.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: transmitting, to a network entity, a scheduling request that indicates full antenna panel availability or partial antenna panel availability; and receiving, from the network entity, an uplink grant that schedules an uplink communication in connection with the scheduling request, wherein the uplink grant is based at least in part on the full antenna panel availability or the partial antenna panel availability indicated by the scheduling request.

Aspect 2: The method of Aspect 1, wherein transmitting the scheduling request comprises: transmitting a first scheduling request that indicates the full antenna panel availability or a second scheduling request that indicates the partial antenna panel availability.

Aspect 3: The method of Aspect 1, wherein transmitting the scheduling request comprises: transmitting the scheduling request with a sequence cyclic shift that indicates the full antenna panel availability or the partial antenna panel availability.

Aspect 4: The method of Aspect 3, wherein transmitting the scheduling request with the sequence cyclic shift that indicates the full antenna panel availability or the partial antenna panel availability comprises: transmitting the scheduling request with a first sequence cyclic shift that corresponds to the full antenna panel availability or a second sequence cyclic shift that corresponds to the partial antenna panel availability.

Aspect 5: The method of any of Aspects 3-4, wherein the scheduling request is a beam failure recovery scheduling request with the sequence cyclic shift that indicates the full antenna panel availability or the partial antenna panel availability.

Aspect 6: The method of Aspect 1, wherein transmitting the scheduling request comprises: transmitting the scheduling request in a first scheduling request resource associated with indicating the full antenna panel availability or a second scheduling request resource associated with indicating the partial antenna panel availability.

Aspect 7: The method of Aspect 6, further comprising: receiving, from the network entity, a scheduling request resource configuration that indicates a configuration for the first scheduling request resource and a configuration for the second scheduling request resource.

Aspect 8: The method of any of Aspects 1-7, wherein transmitting the scheduling request comprises: transmitting the scheduling request multiplexed with hybrid automatic repeat request acknowledgment (HARQ-ACK) information in a physical uplink control channel (PUCCH) communication.

Aspect 9: The method of Aspect 8, wherein the PUCCH communication is a PUCCH format 0 communication.

Aspect 10: The method of any of Aspects 8-9, wherein transmitting the scheduling request multiplexed with HARQ-ACK information in the PUCCH communication comprises: transmitting the PUCCH communication using a sequence cyclic shift that maps to a value for a HARQ-ACK information bit and an indication of the full antenna panel availability or the partial antenna panel availability.

Aspect 11: The method of any of Aspects 8-9, wherein transmitting the scheduling request multiplexed with HARQ-ACK information in the PUCCH communication comprises: transmitting the PUCCH communication using a sequence cyclic shift that maps to a pair of values for two HARQ-ACK information bits and an indication of the full antenna panel availability or the partial antenna panel availability.

Aspect 12: The method of any of Aspects 1-8, wherein transmitting the scheduling request comprises: transmitting, in connection with a first physical uplink control channel (PUCCH) resource in a slot being allocated for the scheduling request and a second PUCCH resource in the slot being allocated for one or more hybrid automatic repeat request acknowledgment (HARQ-ACK) information bits, a PUCCH communication including the scheduling request and the one or more HARQ-ACK information bits in the first PUCCH resource using PUCCH format 1 with a sequence cyclic shift that indicates the full antenna panel availability or the partial antenna panel availability.

Aspect 13: The method of any of Aspects 1-12, wherein the scheduling request indicating the full antenna panel availability or the partial antenna panel availability is based at least in part on an availability of a cooperative UE.

Aspect 14: The method of any of Aspects 1-13, further comprising: transmitting the uplink communication scheduled by the uplink grant.

Aspect 15: A method of wireless communication performed by a network entity, comprising: receiving a scheduling request that indicates full antenna panel availability or partial antenna panel availability associated with a user equipment (UE); and transmitting an uplink grant that schedules an uplink communication in connection with the scheduling request, wherein the uplink grant is based at least in part on the full antenna panel availability or the partial antenna panel availability indicated by the scheduling request.

Aspect 16: The method of Aspect 15, wherein receiving the scheduling request comprises: receiving a first scheduling request that indicates the full antenna panel availability or a second scheduling request that indicates the partial antenna panel availability.

Aspect 17: The method of Aspect 15, wherein receiving the scheduling request comprises: receiving the scheduling request with a sequence cyclic shift that indicates the full antenna panel availability or the partial antenna panel availability.

Aspect 18: The method of Aspect 17, wherein receiving the scheduling request with the sequence cyclic shift that indicates the full antenna panel availability or the partial antenna panel availability comprises: receiving the scheduling request with a first sequence cyclic shift that corresponds to the full antenna panel availability or a second sequence cyclic shift that corresponds to the partial antenna panel availability.

Aspect 19: The method of any of Aspects 17-18, wherein the scheduling request is a beam failure recovery scheduling request with the sequence cyclic shift that indicates the full antenna panel availability or the partial antenna panel availability.

Aspect 20: The method of Aspect 15, wherein receiving the scheduling request comprises: receiving the scheduling request in a first scheduling request resource associated with indicating the full antenna panel availability or a second scheduling request resource associated with indicating the partial antenna panel availability.

Aspect 21: The method of Aspect 20, further comprising: transmitting a scheduling request resource configuration that indicates a configuration for the first scheduling request resource and a configuration for the second scheduling request resource.

Aspect 22: The method of any of Aspects 15-21, wherein receiving the scheduling request comprises: receiving the scheduling request multiplexed with hybrid automatic repeat request acknowledgment (HARQ-ACK) information in a physical uplink control channel (PUCCH) communication.

Aspect 23: The method of Aspect 22, wherein the PUCCH communication is a PUCCH format 0 communication.

Aspect 24: The method of any of Aspects 22-23, wherein receiving the scheduling request multiplexed with HARQ-ACK information in the PUCCH communication comprises: receiving the PUCCH communication using a sequence cyclic shift that maps to a value for a HARQ-ACK information bit and an indication of the full antenna panel availability or the partial antenna panel availability.

Aspect 25: The method of any of Aspects 22-23, wherein receiving the scheduling request multiplexed with HARQ-ACK information in the PUCCH communication comprises: receiving the PUCCH communication using a sequence cyclic shift that maps to a pair of values for two HARQ-ACK information bits and an indication of the full antenna panel availability or the partial antenna panel availability.

Aspect 26: The method of any of Aspects 15-22, wherein receiving the scheduling request comprises: receiving, in connection with a first physical uplink control channel (PUCCH) resource in a slot being allocated for the scheduling request and a second PUCCH resource in the slot being allocated for one or more hybrid automatic repeat request acknowledgment (HARQ-ACK) information bits, a PUCCH communication including the scheduling request and the one or more HARQ-ACK information bits in the first PUCCH resource using PUCCH format 1 with a sequence cyclic shift that indicates the full antenna panel availability or the partial antenna panel availability.

Aspect 27: An apparatus for wireless communication at a device, comprising a processor; memory coupled with the processor; and instructions stored in the memory and executable by the processor to cause the apparatus to perform the method of one or more of Aspects 1-14.

Aspect 28: A device for wireless communication, comprising a memory and one or more processors coupled to the memory, the one or more processors configured to perform the method of one or more of Aspects 1-14.

Aspect 29: An apparatus for wireless communication, comprising at least one means for performing the method of one or more of Aspects 1-14.

Aspect 30: A non-transitory computer-readable medium storing code for wireless communication, the code comprising instructions executable by a processor to perform the method of one or more of Aspects 1-14.

Aspect 31: A non-transitory computer-readable medium storing a set of instructions for wireless communication, the set of instructions comprising one or more instructions that, when executed by one or more processors of a device, cause the device to perform the method of one or more of Aspects 1-14.

Aspect 32: An apparatus for wireless communication at a device, comprising a processor; memory coupled with the processor; and instructions stored in the memory and executable by the processor to cause the apparatus to perform the method of one or more of Aspects 15-26.

Aspect 33: A device for wireless communication, comprising a memory and one or more processors coupled to the memory, the one or more processors configured to perform the method of one or more of Aspects 15-26.

Aspect 34: An apparatus for wireless communication, comprising at least one means for performing the method of one or more of Aspects 15-26.

Aspect 35: A non-transitory computer-readable medium storing code for wireless communication, the code comprising instructions executable by a processor to perform the method of one or more of Aspects 15-26.

Aspect 36: A non-transitory computer-readable medium storing a set of instructions for wireless communication, the set of instructions comprising one or more instructions that, when executed by one or more processors of a device, cause the device to perform the method of one or more of Aspects 15-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a network entity, a scheduling request that indicates full antenna panel availability or partial antenna panel availability; and
receive, from the network entity, an uplink grant that schedules an uplink communication in connection with the scheduling request, wherein the uplink grant is based at least in part on the full antenna panel availability or the partial antenna panel availability indicated by the scheduling request.

2. The UE of claim 1, wherein the one or more processors, to transmit the scheduling request, are configured to:
transmit a first scheduling request that indicates the full antenna panel availability or a second scheduling request that indicates the partial antenna panel availability.

3. The UE of claim 1, wherein the one or more processors, to transmit the scheduling request, are configured to:
transmit the scheduling request with a sequence cyclic shift that indicates the full antenna panel availability or the partial antenna panel availability.

4. The UE of claim 3, wherein the one or more processors, to transmit the scheduling request with the sequence cyclic shift that indicates the full antenna panel availability or the partial antenna panel availability, are configured to:
transmit the scheduling request with a first sequence cyclic shift that corresponds to the full antenna panel availability or a second sequence cyclic shift that corresponds to the partial antenna panel availability.

5. The UE of claim 3, wherein the scheduling request is a beam failure recovery scheduling request with the sequence cyclic shift that indicates the full antenna panel availability or the partial antenna panel availability.

6. The UE of claim 1, wherein the one or more processors, to transmit the scheduling request, are configured to:
transmit the scheduling request in a first scheduling request resource associated with indicating the full antenna panel availability or a second scheduling request resource associated with indicating the partial antenna panel availability.

7. The UE of claim 6, wherein the one or more processors are further configured to:
receive, from the network entity, a scheduling request resource configuration that indicates a configuration for the first scheduling request resource and a configuration for the second scheduling request resource.

8. The UE of claim 1, wherein the one or more processors, to transmit the scheduling request, are configured to:
transmit the scheduling request multiplexed with hybrid automatic repeat request acknowledgment (HARQ-ACK) information in a physical uplink control channel (PUCCH) communication.

9. The UE of claim 8, wherein the PUCCH communication is a PUCCH format 0 communication.

10. The UE of claim 8, wherein the one or more processors, to transmit the scheduling request multiplexed with HARQ-ACK information in the PUCCH communication, are configured to:
transmit the PUCCH communication using a sequence cyclic shift that maps to a value for a HARQ-ACK information bit and an indication of the full antenna panel availability or the partial antenna panel availability.

11. The UE of claim 8, wherein the one or more processors, to transmit the scheduling request multiplexed with HARQ-ACK information in the PUCCH communication, are configured to:
transmit the PUCCH communication using a sequence cyclic shift that maps to a pair of values for two HARQ-ACK information bits and an indication of the full antenna panel availability or the partial antenna panel availability.

12. The UE of claim 1, wherein the one or more processors, to transmit the scheduling request, are configured to:
transmit, in connection with a first physical uplink control channel (PUCCH) resource in a slot being allocated for the scheduling request and a second PUCCH resource in the slot being allocated for one or more hybrid automatic repeat request acknowledgment (HARQ-ACK) information bits, a PUCCH communication including the scheduling request and the one or more HARQ-ACK information bits in the first PUCCH resource using PUCCH format 1 with a sequence cyclic shift that indicates the full antenna panel availability or the partial antenna panel availability.

13. The UE of claim 1, wherein the scheduling request indicating the full antenna panel availability or the partial antenna panel availability is based at least in part on an availability of a cooperative UE.

14. The UE of claim 1, wherein the one or more processors are further configured to:
transmit the uplink communication scheduled by the uplink grant.

15. A network entity for wireless communication, comprising:
a memory; and
one or more processors, coupled to the memory, configured to:
receive a scheduling request that indicates full antenna panel availability or partial antenna panel availability associated with a user equipment (UE); and
transmit an uplink grant that schedules an uplink communication in connection with the scheduling request, wherein the uplink grant is based at least in part on the full antenna panel availability or the partial antenna panel availability indicated by the scheduling request.

16. The network entity of claim 15, wherein the one or more processors, to receive the scheduling request, are configured to:
receive a first scheduling request that indicates the full antenna panel availability or a second scheduling request that indicates the partial antenna panel availability.

17. The network entity of claim 15, wherein the one or more processors, to receive the scheduling request, are configured to:
receive the scheduling request with a sequence cyclic shift that indicates the full antenna panel availability or the partial antenna panel availability.

18. The network entity of claim 17, wherein the one or more processors, to receive the scheduling request with the sequence cyclic shift that indicates the full antenna panel availability or the partial antenna panel availability, are configured to:
receive the scheduling request with a first sequence cyclic shift that corresponds to the full antenna panel availability or a second sequence cyclic shift that corresponds to the partial antenna panel availability.

19. The network entity of claim 15, wherein the one or more processors, to receive the scheduling request, are configured to:
receive the scheduling request in a first scheduling request resource associated with indicating the full antenna panel availability or a second scheduling request resource associated with indicating the partial antenna panel availability.

20. The network entity of claim 19, wherein the one or more processors are further configured to:
transmit a scheduling request resource configuration that indicates a configuration for the first scheduling request resource and a configuration for the second scheduling request resource.

21. A method of wireless communication performed by a user equipment (UE), comprising:
transmitting, to a network entity, a scheduling request that indicates full antenna panel availability or partial antenna panel availability; and
receiving, from the network entity, an uplink grant that schedules an uplink communication in connection with the scheduling request, wherein the uplink grant is based at least in part on the full antenna panel availability or the partial antenna panel availability indicated by the scheduling request.

22. The method of claim 21, wherein transmitting the scheduling request comprises:
transmitting a first scheduling request that indicates the full antenna panel availability or a second scheduling request that indicates the partial antenna panel availability.

23. The method of claim 21, wherein transmitting the scheduling request comprises:
transmitting the scheduling request with a sequence cyclic shift that indicates the full antenna panel availability or the partial antenna panel availability.

24. The method of claim 23, wherein transmitting the scheduling request with the sequence cyclic shift that indicates the full antenna panel availability or the partial antenna panel availability comprises:
transmitting the scheduling request with a first sequence cyclic shift that corresponds to the full antenna panel availability or a second sequence cyclic shift that corresponds to the partial antenna panel availability.

25. The method of claim 21, wherein transmitting the scheduling request comprises:
transmitting the scheduling request in a first scheduling request resource associated with indicating the full antenna panel availability or a second scheduling request resource associated with indicating the partial antenna panel availability.

26. The method of claim 25, further comprising:
receiving, from the network entity, a scheduling request resource configuration that indicates a configuration for the first scheduling request resource and a configuration for the second scheduling request resource.

27. A method of wireless communication performed by a network entity, comprising:
receiving a scheduling request that indicates full antenna panel availability or partial antenna panel availability associated with a user equipment (UE); and
transmitting an uplink grant that schedules an uplink communication in connection with the scheduling request, wherein the uplink grant is based at least in part on the full antenna panel availability or the partial antenna panel availability indicated by the scheduling request.

28. The method of claim 27, wherein receiving the scheduling request comprises:
receiving a first scheduling request that indicates the full antenna panel availability or a second scheduling request that indicates the partial antenna panel availability.

29. The method of claim 27, wherein receiving the scheduling request comprises:
receiving the scheduling request with a sequence cyclic shift that indicates the full antenna panel availability or the partial antenna panel availability.

30. The method of claim 27, wherein receiving the scheduling request comprises:
receiving the scheduling request in a first scheduling request resource associated with indicating the full antenna panel availability or a second scheduling request resource associated with indicating the partial antenna panel availability.
